(19) United States
(12) Patent Application Publication
(10) Pub. No.: US 2010/0079251 A1
(43) Pub. Date: Apr. 1, 2010

(54) FRAME PROCESSING CIRCUIT

(75) Inventor: Kazuyuki OKAMOTO, Kanagawa (JP)

Correspondence Address: YOUNG & THOMPSON, 209 Madison Street, Suite 500, Alexandria, VA, 22314, US

(73) Assignees: NEC ELECTRONICS CORPORATION, Kanagawa (JP); NEC CORPORATION, Tokyo (JP)

(21) Appl. No.: 12/567,176

(22) Filed: Sep. 25, 2009

(30) Foreign Application Priority Data
Sep. 26, 2008 (JP) 2008-248513

(51) Int. Cl. H04Q 5/22; G06F 15/16

(52) U.S. Cl. 340/10.1; 709/236

(57) ABSTRACT

A frame processing circuit performs frame processing that is creation processing of creating an RFID data frame from a payload or analysis processing of analyzing an RFID data frame and obtaining a payload. The frame processing includes m (1≦m≦n) number of processing steps according to a type of data frame among n (n is an integer of 2 or above) number of processing steps. The frame processing circuit includes n-number of processing blocks that respectively execute the n-number of processing steps. The n-number of processing blocks include a bypassable block where setting of whether to bypass processing can be made according to a type of data frame, that performs processing of a relevant step on received data and outputs processed data if no bypassing is set, and outputs received data without performing any processing if bypassing is set.

### BACKGROUND

1. Field of the Invention

The present invention relates to a frame processing technique and, particularly, a technique of creating an RFID (Radio Frequency Identification) data frame or a technique of analyzing an RFID data frame and obtaining a payload.

2. Description of Related Art

RFID technology is widely used in fields of physical distribution, electronic money and so on, and various protocols are standardized. An RFID system generally includes an RFID tag and an RFID reader/writer. In order to establish communication between the RFID tag and the RFID reader/writer, it is necessary for the RFID tag and the RFID reader/writer to conform to the same protocol.

There are a plurality of types of RFID data frames in the same protocol, and different types of data frames have different data formats.

For example, in the case of a protocol defined by ISO14443A, there are a standard frame and a short frame. FIG. 19 shows the format of the two types of frames.

Referring to FIG. 19, the standard frame is composed of SOC, Payload, CRC and EOC. SOC is start data (which is also called “header”), Payload and CRC are a payload and CRC data containing a parity bit, and EOC is end data. Payload contains a data command.

The short frame is composed of start data S, Payload and end data E. The short frame does not contain CRC data, and no parity data is added to Payload. Further, the start data S of the short frame is different from the start data SOC of the standard frame, and the end data E of the short frame is also different from the end data LOC of the standard frame.

Accordingly, processing of creating the standard frame and processing of creating the short frame (which are referred to hereinafter as creation processing) are different. The creation processing of the standard frame includes a processing step of adding CRC data to Payload and a processing step of performing parity operation on Payload and CRC data and adding a parity bit.

On the other hand, the creation processing of the short frame does not include the above-described two processing steps.

Further, in a step of adding the start data, which is included in the both creation processing of the standard frame and the short frame, the start data to be added is different between the standard frame and the short frame. The same holds true in a step of adding the end data.

Because both of the standard frame and the short frame are used for communication, a section to perform the data frame creation processing in the RFID reader/writer and the RFID tag supporting ISO14443A needs to be capable of creating the both frames.

Further, analysis processing for obtaining Payload from a received data frame is also different between the standard frame and the short frame, and a section to perform the data frame analysis processing needs to be capable of analyzing the both frames.

In order to satisfy the above needs, two techniques can be used. One is a technique of implementing the above configuration by hardware. For example, a circuit for creating the standard frame and a circuit for creating the short frame are provided and switched according to the type of data frame to be created. The other one is a technique of creating a data frame by software.

The same holds true for the section to perform the data frame analysis processing.

With the recent diversification and commercialization of RFID standards, it is desired for one RFID device (an RFID reader/writer or an RFID tag) to be compatible with a plurality of protocols.

FIG. 20 is a view showing FIG. 1 of Japanese Unexamined Patent Application Publication No. 2007-334703 with different reference numerals, which illustrates an RFID system compatible with a plurality of protocols disclosed therein.

The RFID system shown in FIG. 20 includes an RFID tag 10 and an RFID reader/writer device 13. The RFID tag 10 includes two RFID units (an RFID unit A11 and an RFID unit B12), and each of the two RFID units includes an antenna that receives radio waves, an electromotive force unit that rectifies high-frequency radio waves transmitted from the RFID reader/writer device 13 and generates an operating power, an RF unit that performs RF modulation and demodulation, a protocol processing unit, and a storage unit that stores ID data and user data.

The protocol processing unit performs creation and analysis of a data frame. The protocol processing unit of the RFID unit A11 conforms to a first protocol, and the protocol processing unit of the RFID unit B12 conforms to a second protocol.

Further, in order to reduce a circuit scale, it has been proposed to use a shareable part of the two RFID units in common in the RFID tag 10. FIG. 21 a view showing FIG. 5 of Japanese Unexamined Patent Application Publication No. 2007-334703 with different reference numerals. As shown in FIG. 21, the RFID tag 10 includes an antenna 20, an antenna 21, a common RF unit 22, a common electromotive force unit 23, an RFID common protocol processing unit 24, and a common storage unit 27.

The RFID common protocol processing unit 24 performs creation and analysis of a data frame, and it includes a first protocol processing unit 25 and a second protocol processing unit 26. The first protocol processing unit 25 conforms to a first protocol and performs creation and analysis of a data frame of the first protocol. The second protocol processing unit 26 conforms to a second protocol and performs creation and analysis of a data frame of the second protocol.

The RFID tag 10 shown in FIG. 21 is compatible with both the first protocol and the second protocol, and it has a reduced circuit scale through shared use of the RF unit, the electromotive force unit and the storage unit.

Further, a reader/writer main body 14 also includes RFID protocol processing units for respective protocols in order to be compatible with a plurality of protocols.

### SUMMARY

The present inventors have found the following problems. The technique of providing and switching between circuits conforming to respective types of data frames in an RFID device in order to enable creation and analysis of different types of data frames in one protocol has a problem that a circuit scale is large. Further, the technique of performing creation and analysis of a data frame by software has a problem that a processing speed is lower than when using hardware and that a circuit scale is large due to an increase in memory capacity.

In an RFID device compatible with a plurality of protocols, such as the RFID tag 10 shown in FIG. 21, protocol processing units respectively conforming to the plurality of protocols have the above-described problem just like an RFID device compatible with a single protocol only. Further, because the protocol processing units are provided for the respective protocols, a circuit scale further increases.

An exemplary aspect of an embodiment of the present invention is a frame processing circuit. The frame processing circuit performs frame processing that is creation processing of creating an RFID data frame from a payload or analysis processing of analyzing an RFID data frame and obtaining a payload, which includes m (1≦m≦n) number of processing steps according to a type of data frame among n (n is an integer of 2 or above) number of processing steps. The frame processing circuit includes n-number of processing blocks that respectively execute the n-number of processing steps.

The processing blocks include a bypassable block where setting of whether to bypass processing can be made according to a type of data frame, that performs processing of a relevant step on received data and outputs processed data if no bypassing is set and outputs received data without performing any processing if bypassing is set.

The technique according to the exemplary aspect of an embodiment of the present invention described above enables suppression of a circuit scale of an RFID device and prevention of a decrease in processing speed.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a view to describe creation processing of a standard frame based on ISO14443A;

FIG. 2 is a view to describe creation processing of a short frame based on ISO14443A;

FIG. 3 is a view to describe analysis processing of a standard frame based on ISO14443A;

FIG. 4 is a view to describe analysis processing of a short frame based on ISO14443A;

FIG. 5 is a view showing exemplary structures of data frames of a plurality of protocols;

FIG. 6 is a schematic view showing a frame processing circuit to describe the principle of the present invention;

FIG. 7 is a view showing the details of frame processing on three types of frames to be processed by the frame processing circuit shown in FIG. 6;

FIG. 8 is a view showing a bypassable block in the frame processing circuit shown in FIG. 6;

FIG. 9 is a view showing a parameter variable block in the frame processing circuit shown in FIG. 6;

FIG. 10 is a view showing a processing scheme variable block in the frame processing circuit shown in FIG. 6;

FIG. 11 is a view showing an RFID system according to an exemplary embodiment of the present invention;

FIG. 12 is a view showing a frame creation/analysis unit in the RFID system shown in FIG. 11;

FIG. 13 is a view showing a frame creation circuit in the frame creation/analysis unit shown in FIG. 12;

FIG. 14 is a view showing a frame analysis circuit in the frame creation/analysis unit shown in FIG. 12;

FIG. 15 is a view showing the flow of creation processing of a standard frame of each type of protocol in the frame creation circuit shown in FIG. 13;

FIG. 16 is another view showing the flow of creation processing of a standard frame of each type of protocol in the frame creation circuit shown in FIG. 13;

FIG. 17 is a view showing the flow of analysis processing of a standard frame of each type of protocol in the frame analysis circuit shown in FIG. 14;

FIG. 18 is another view showing the flow of analysis processing of a standard frame of each type of protocol in the frame analysis circuit shown in FIG. 14;

FIG. 19 is a view showing a format of a standard frame and a short frame based on ISO14443A;

FIG. 20 is a view showing an RFID system according to prior art; and

FIG. 21 is a view showing an RFID tag in the RFID system shown in FIG. 20.

### DETAILED DESCRIPTION OF THE EXEMPLARY EMBODIMENTS

The following description and the attached drawings are appropriately shortened and simplified to clarify the explanation. In the drawings, the identical structural elements and equivalents are denoted by the identical reference symbols, and the redundant explanation thereof is omitted. Further, the items having no direct relevance to the description of the present invention and generally known in the art are also omitted.

Before describing a specific exemplary embodiment of the present invention, the principle underlying the present invention is described hereinafter.

The inventor of the present invention has conduced intensive study on creation and analysis of a data frame in an RFID device and found the followings. The findings are described hereinafter by using a protocol defined by ISO14443A as an example.

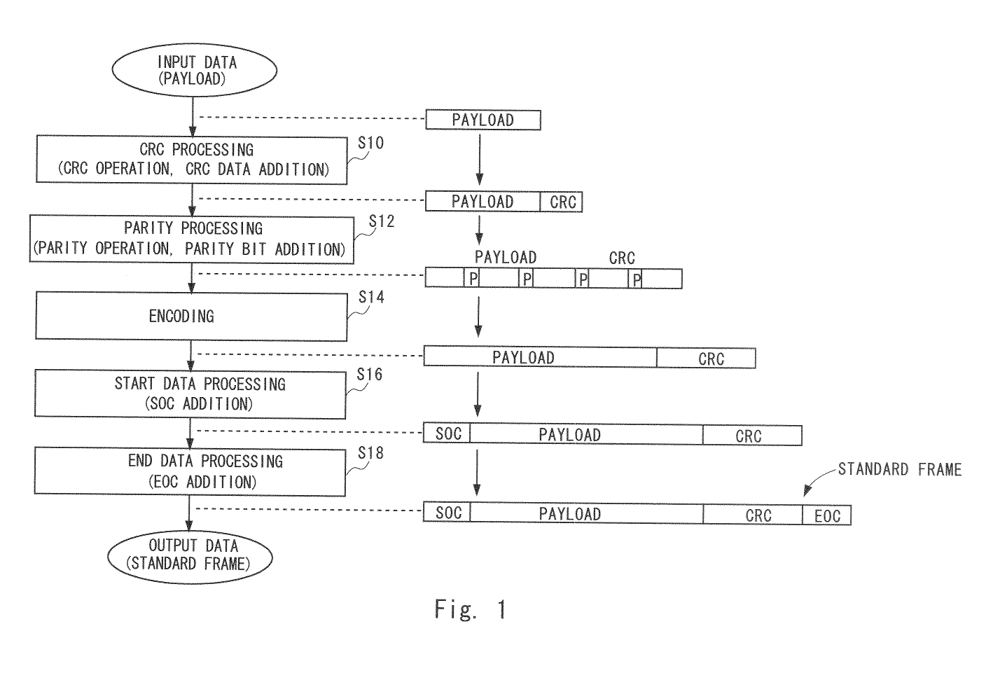

The left part of FIG. 1 is a flowchart showing an example of the flow of creation processing of a standard frame based on ISO14443A. The right part of FIG. 1 shows a chance in data with execution of the processing shown in the flowchart on the left. Although the data is represented by a rectangular frame in FIG. 1, the length of the frame does not indicate the length of the data. The same holds true for each figure used in the description below.

Referring to FIG. 1. the standard frame is created by sequentially executing CRC processing (S10), parity processing (S12), encoding (S14), start data processing (S16) and end data processing (S18). In the CRC processing (S10), CRC operation is performed, and CRC data is added to Payload. In the parity processing (S12), parity operation is performed, and a parity bit P is added to the data obtained by the CRC processing (S10). In the encoding (S14), the data obtained by the parity processing (S12) is encoded. In the start data processing (S16), start data (which is SOC in this example) is added to the data obtained by the encoding (S14). Finally, in the end data processing (S18), end data (which is EOC in this example) is added, so that a standard frame is created. In the drawings of the present invention, the data before encoding and the data after encoding are not particularly distinguished by symbols when there is a low possibility of confusion and no problem in understanding the gist of the invention.

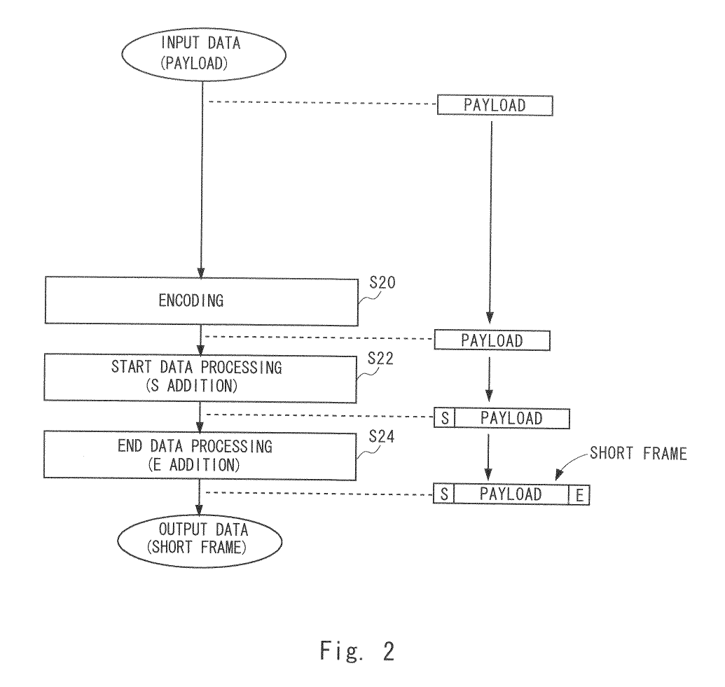

The left part of FIG. 2 is a flowchart showing an example of the flow of creation processing of a short frame based on ISO14443A. The right part of FIG. 2 shows a change in data with execution of the processing shown in the flowchart on the left.

Referring to FIG. 2, the short frame is created by sequentially executing encoding (S20), start data processing (S22) and end data processing (S24). In the start data processing (S22), start data (which is S in this example) is added to Payload. In the end data processing (S24), end data (which is F in this example) is added, so that a short frame is created.

As obvious from a comparison of FIG. 1 and FIG. 2, the creation processing of a standard frame includes five steps, and the creation processing of a short frame includes three steps. The step S22 (start data processing) in the creation processing of a short frame and the step S16 (start data processing) in the creation processing of a standard frame are the same in that they both “add start data at the start of received data”, except that the description of the start data is “S” or “SOC”. Likewise, the step S24 (end data processing) in the creation processing of a short frame and the step S18 (end data processing) in the creation processing of a standard frame are the same in that they both “add end data at the end of received data”, except that the description of the end data is “E” or “EOC”.

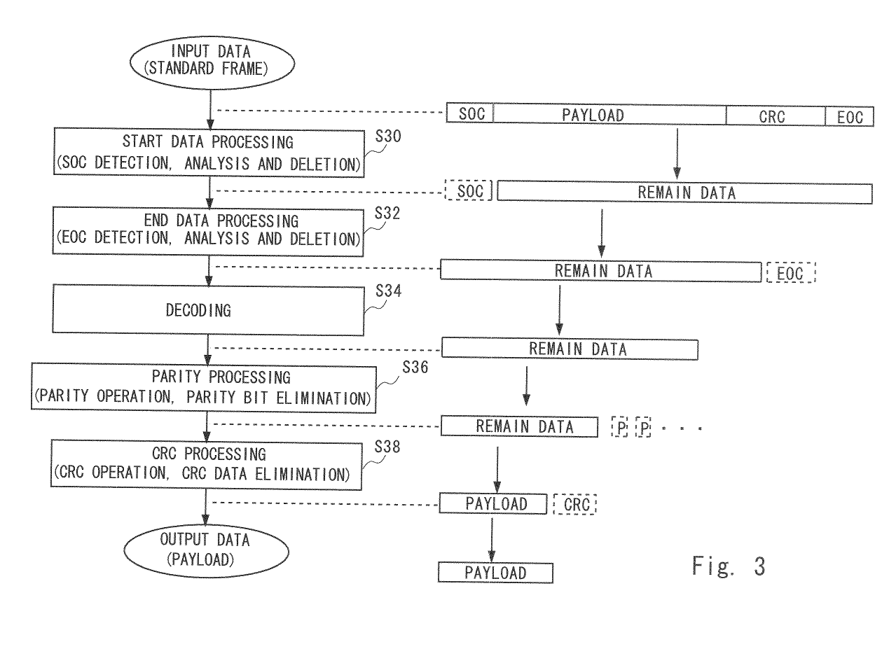

The left part of FIG. 3 is a flowchart showing an example of the flow of analysis processing of a standard frame based on ISO14443A. The right part of FIG. 3 shows a change in data with execution of the processing shown in the flowchart on the left in FIG. 3, the dotted frame indicates data that is deleted by the processing. The same holds true for the following drawings. Further, in the drawings of the present invention, the data before encoding and the data after encoding are not particularly distinguished by symbols when there is a low possibility of confusion and no problem in understanding the gist of the invention.

Referring to FIG. 3, the standard frame is analyzed by sequentially executing start data processing (S30), end data processing (S32), decoding (S34), parity processing (S36) and CRC processing (S38).

In the start data processing (S30), detection and analysis of the start data SOC of the standard frame are performed. If the detected start data SOC and an expected value match, the start data SOC is deleted. On the other hand, if the detected start data SOC and an expected value do not match, it results in error and the processing is discontinued.

In the end data processing (S32), detection and analysis of the end data EOC in the data after the start data SOC is deleted by the start data processing (S30) (which is referred to hereinafter as Remain Data) are performed. If the detected end data LOC and an expected value match, the end data EOC is deleted. On the other hand, if the detected end data EOC and an expected value do not match, it results in error and the processing is discontinued.

In the decoding (S34), Remain Data obtained by the end data processing (S32) is decoded. If an unusual event occurs during decoding, it results in error and the processing is discontinued.

In the parity processing (S36), parity operation is performed, and a parity bit P is eliminated from the decoded Remain Data. In this step, if an unusual event occurs, such as when the parity bit P is not detected, it results in error and the processing is discontinued.

Finally, in the CRC processing (S38), CRC operation is performed, and the CRC data is eliminated from Remain Data after the parity processing (S36), so that Payload is obtained. The analysis processing or the standard frame is thereby completed. If an unusual event occurs as a result of CRC check by the CRC operation, it results in error and the processing is discontinued.

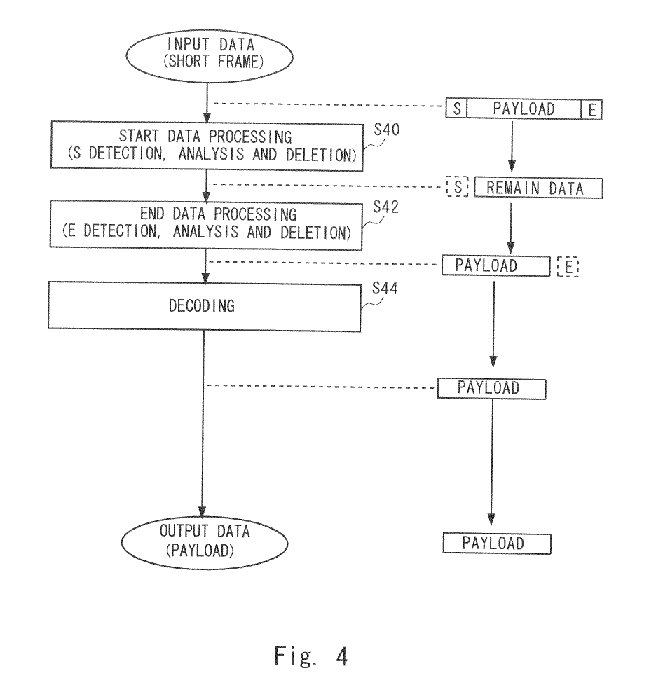

The left part of FIG. 4 is a flowchart showing an example of the flow of analysis processing of a short frame based on ISO14443A. The right part of FIG. 4 shows a change in data with execution of the processing shown in the flowchart on the left.

Referring to FIG. 4, the short frame is analyzed by sequentially executing start data processing (S40), end data processing (S42) and decoding (S44). In the start data processing (S40), detection and analysis of the start data S of the short frame are performed. If the detected start data S and an expected value match, the start data S is deleted. On the other hand, if the detected start data S and an expected value do not match, it results in error and the processing is discontinued.

In the end data processing (S42), detection and analysis of the end data E in Remain Data that is obtained by the start data processing (S40) are performed. If the detected end data E and an expected value match, the end data E is deleted. On the other hand, if the detected end data E and an expected value do not match, it results in error and the processing is discontinued.

In the decoding (S44), Remain Data obtained by the end data processing (S42) is decoded, so that Payload is obtained. The analysis processing of the short frame is thereby completed. If an unusual event occurs during decoding, it results in error and the processing is discontinued.

As obvious from a comparison of FIG. 3 and FIG. 4, the analysis processing of a standard frame includes five steps, and the analysis processing of a short frame includes three steps. The step S40 (start data processing) in the analysis processing of a short frame and the step S30 (start data processing) in the analysis processing of a standard frame are the same in that they both “detect, analyze and delete start data at the start of received data”, except that the description of the start data is “S” or “SOC”. Likewise, the step S42 (end data processing) in the analysis processing of a short frame and the step S32 (end data processing) in the analysis processing of a standard frame are the same in that they both “detect, analyze and delete end data at the end of received data”, except that the description of the end data is “E” or “EOC”.

Thus, according to ISO14443A, if the creation processing of a standard frame is divided into steps of CRC processing, parity processing, encoding, start data processing and end data processing, three steps (start data processing, encoding and end data processing) among those steps make up the creation processing of a short frame. The same holds true for the analysis processing.

In the following description, “frame processing” is used as the meaning of either creation processing or analysis processing of a data frame for convenience of description.

Further, in other RFID protocols also, not limited to ISO14443A, frame processing can be divided into steps in such a way that part of steps involved in a plurality of steps that make up the frame processing of one type of data frame make up the frame processing of another type of data frame. Further, in the part of steps, if a parameter used in the processing is the same between different types of data frames, there is no need to change the parameter according to the type of data frame, and, if a parameter used in the processing is different between different types of data frames, such as the short frame and the standard frame based on ISO14443A, the parameter can be changed according to the type of data frame. Furthermore, in the part of steps, if a processing scheme is different between different types of data frames, sections for performing the processing of the step can be provided for respective processing schemes and switched according to the type of data frame.

Furthermore, the above holds true for data frames according to a plurality of different protocols, not only different types of data frames according to one protocol. This is described hereinafter by using several protocols as examples. For simplification, a standard frame in each protocol is described as an example. Although it depends on protocol whether the start data is higher-order bits (i.e. the end data is lower-order bits) or the start data is lower-order bits (i.e. the end data is higher-order bits), transfer of a data frame is performed from the start data. Elements of a data frame are described hereinafter in the sequence of transfer.

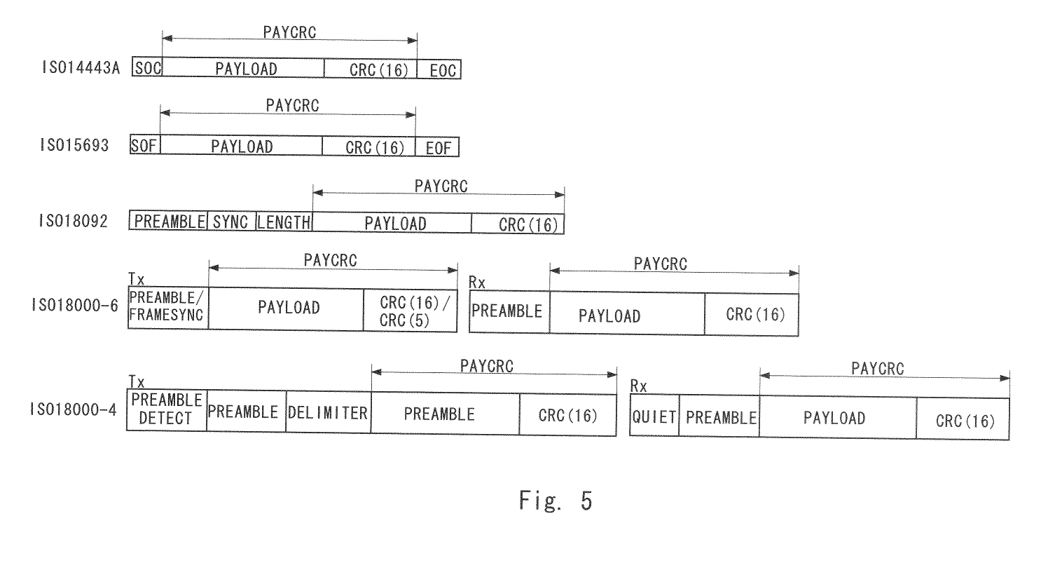

FIG. 5 shows structures of standard frames defined by five RFID protocols, ISO14443A, ISO15693, ISO18092, ISO18000-6 and ISO18000-4, and processed by an RFID reader/writer. In ISO18000-6 and ISO18000-4, the format of a standard frame transmitted from an RFID reader/writer and the format of a received frame are different, which are respectively shown in FIG. 5. In each standard frame, the numeral in parentheses after “CRC” indicates the number of bits of CRC data. The elements of each standard frame are indicated by the term used in the corresponding protocol.

As shown in FIG. 5, the standard frame of ISO14443A is composed of start data SOC, Payload, 16-bit CRC data and end data EOC. For convenience of description. Payload and CRC are hereinafter referred to collectively as PAYCRC in some cases. PAYCRC is generally encoded in the creation processing, and decoded in the analysis processing.

The standard frame of ISO15693 is composed of start data SOF, PAYCRC and end data EOF. CRC is 16 bits.

The standard frame of ISO18092 is composed of start data (Preamble+SYNC+LENGTH) and PAYCRC. SYNC in the start data of the standard frame of ISO18092 contains Polarity data that is used when decoding PAYCRC of ISO18092. LENGTH indicating the data length of PAYCRC is also used when decoding PAYCRC. CRC of the standard frame of ISO18092 is also 16 bits. The standard frame of ISO18092 does not contain end data.

According to ISO18000-6, the standard frame transmitted by an RFID reader/writer is composed of start data and PAYCRC. There are two types of the start data: Preamble and Framesync. Further, there are two types of CRC: 16 bits and 5 bits. The standard frame received by the RFID reader/writer is composed of start data Preamble and PAYCRC, and CRC is 16 bits. The standard frame of ISO18000-6 also does not contain end data.

According to ISO18000-4, the standard frame transmitted by an RFID reader/writer is composed of start data (Preamble detect+Preamble+Delimiter) and PAYCRC, and CRC is 16 bits. The standard frame received by the RFID reader/writer is composed of start data (Quiet+Preamble) and PAYCRC, and CRC is 16 bits. The standard frame of ISO18000-4 also does not contain end data.

Further, although not shown in FIG. 5, a parity bit is inserted or not inserted to data of PAYCRC depending on protocol.

As obvious from the structures of the standard frames based on the respective protocols shown in FIG. 5, if the creation processing of a standard frame is divided into steps of CRC processing, parity processing, encoding, start data processing and end data processing, all the steps are necessary when creating the standard frame in the case of ISO14443A only. In the creation of the standard frames of the other protocols, although the steps of encoding, CRC processing, and start data processing are included in all protocols, the other steps are not included in some protocols.

Therefore, if a section for performing frame creation in an RFID reader/writer is configured to be made up of a CRC processing block, a parity processing block, an encoding block, a start data processing block and an end data processing block, and the parity processing block and the end data processing block are configured to be bypassable, it is compatible with the creation of the standard frames based on the five protocols shown in FIG. 5. If a parameter to be used for processing of the step differs by protocol, a parameter corresponding to each protocol can be set to the processing block. Further, for a step in which a processing scheme differs between different protocols, processing units of the step can be provided for respective processing schemes and switched according to a protocol. For example, regarding the encoding processing, encoding units are provided for respective encoding schemes and switched according to a protocol.

Further, if a section for performing frame analysis in an RFID reader/writer is configured to be made up of a start data processing block, an end data processing block, a decoding block, a parity processing block and a CRC processing block, and the parity processing block and the end data processing block are configured to be bypassable, it is compatible with the analysis of the standard frames based on the five protocols shown in FIG. 5. If a parameter to be used for processing of the step differs by protocol, a parameter corresponding to a protocol can be set to the processing block. Further, for a step in which a processing scheme differs between different protocols, processing units of the step can be provided for respective processing schemes and switched according to a protocol. For example, in the case of ISO18092, it is necessary to perform detection of LENGTH, which is not performed in the case of other protocols, at the time of decoding. Therefore, two types of blocks for performing decoding, one performs decoding after detecting LENGTH and the other one performs decoding without detecting LENGTH, can be provided and switched at the time of processing in the decoding step.

Further, for some types of frames, it is defined to encode the start data and the end data or a part of those. In such a case, when setting a parameter to the start data processing block and the end data processing block, encoded start data and encoded end data can be set.

On the basis of the above findings, the inventor of the present invention proposes a frame processing circuit that enables suppression of a circuit scale of an RFID device and prevention of a decrease in processing speed. The “frame processing circuit” is either a circuit that creates a data frame or a circuit that analyzes a data frame.

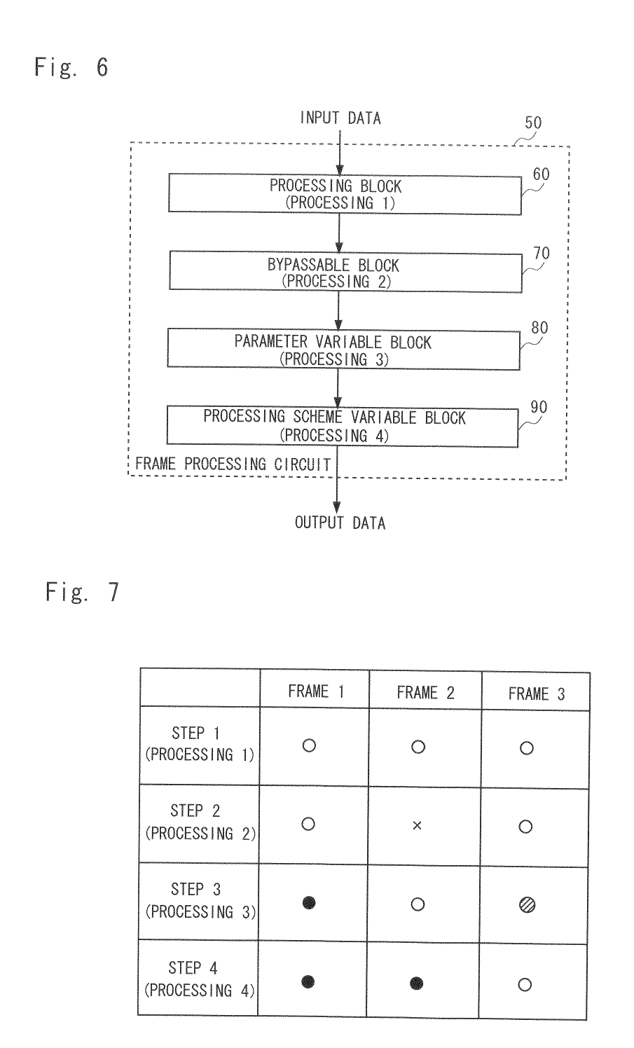

FIG. 6 is a schematic view showing a frame processing circuit that is proposed by the inventor of the present invention. In a frame processing circuit 50 shown therein, a processing 60, a bypassable block 70, a parameter variable block 80 and a processing scheme variable block 90 are connected sequentially. Note that, FIG. 6 is a schematic view for describing the principle of the present invention, and the sequence of connection of processing blocks and the number of processing blocks are not limited to those shown in FIG. 6. Further, not all of the processing blocks other than the bypassable block 70 are always included.

The frame processing circuit 50 shown in FIG. 6 is compatible with frame processing of different types of data frames. The types of data frames are not limited to the types of different formats defined by a single protocol but involve the types of protocols.

Assume, for example, that there are three types of data frames: frames 1 to 3. FIG. 7 shows an example of steps that make up the frame processing of those frames.

As shown in FIG. 7, the frame processing of the frame 1 includes a step 1, a step 2, a step 3 and a step 4.

The frame processing of the frame 2 includes a step 1, a step 3 and a step 4.

The frame processing of the frame 3 includes a step 1, a step 2, a step 3 and a step 4.

The processing corresponding to the step 1, the step 2, the step 3 and the step 4 are referred to as processing 1, processing 2, processing 3 and processing 4, respectively.

A parameter that is used in the step 3 (processing 3) differs among the frame 1, the frame 2 and the frame 3, and a processing scheme of the step 4 (processing 4) differs between the frames 1 and 2 and the frame 3. The processing scheme of the step 4 corresponding to the frame 1 and the frame 2 is referred to as a first processing scheme, and the processing scheme of the step 4 corresponding to the frame 3 is referred to as a second processing scheme.

In the frame processing circuit 50, the processing block 60 executes the processing 1, the bypassable block 70 can execute the processing 2, the parameter variable block 80 executes the processing 3, and the processing scheme variable block 90 executes the processing 4.

The processing 1 that is executed by the processing block 60 is included in any frame processing of the frames 1 to 3, and a parameter used in the processing and a processing scheme are the same among the frames 1 to 3.

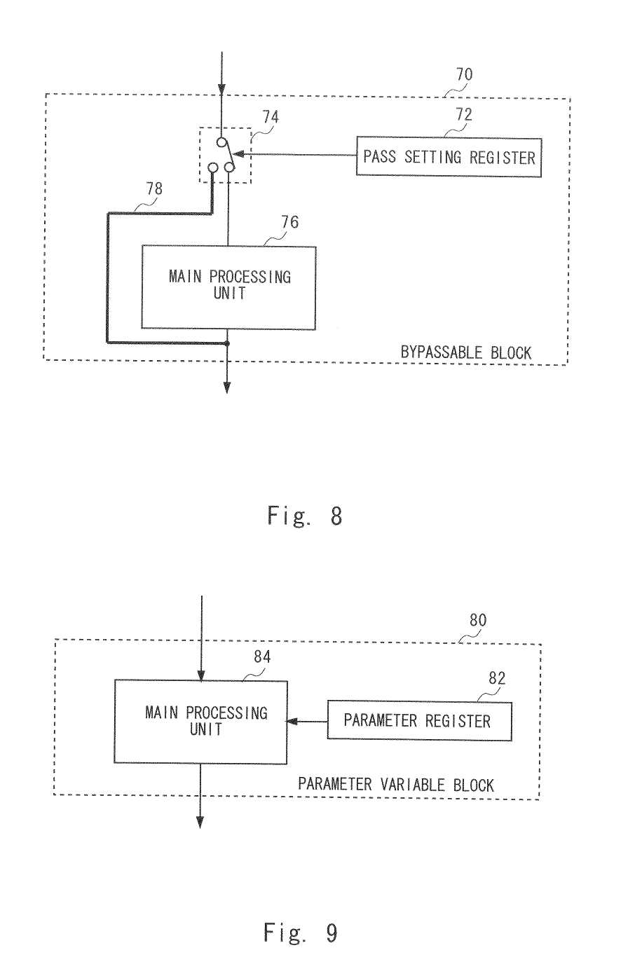

The bypassable block 70 performs the processing 2 on the data from the processing block 60 and outputs a result to the parameter variable block 80, or outputs the data from the processing block 60 to the parameter variable block 80 in the subsequent stage without performing the processing 2. FIG. 8 shows an example of the configuration of the bypassable block 70.

Referring to FIG. 8, the bypassable block 70 includes a pass setting register 72, a pass switch 74, a main processing unit 76 and a bypass 78.

The main processing unit 76 executes the processing 2. The pass setting register 72 stores a set value that indicates whether to perform the processing 2 on the data from the processing block 60. The bypass 78 is a connection line for outputting the data from the processing block 60 to the parameter variable block 80 without performing any processing. The pass switch 74 refers to the set value stored in the pass setting register 72 and switches whether to output the data from the processing block 60 to the main processing unit 76 or the bypass 78.

If the set value stored in the pass setting register 72 indicates “no bypassing”, the pass switch 74 outputs the data from the processing block 60 to the main processing unit 76. The data from the processing block 60 is thereby processed (processing 2) by the main processing unit 76 and then output to the parameter variable block 80.

On the other hand, if the set value stored in the pass setting register 72 indicates “bypassing”, the pass switch 74 outputs the data from the processing block 60 to the bypass 78. The data from the processing block 60 is thereby output to the parameter variable block 80 as it is.

With such a configuration of the bypassable block 70, it is possible to control whether to bypass the processing 2 when performing the frame processing by changing the set value stored in the pass setting register 72.

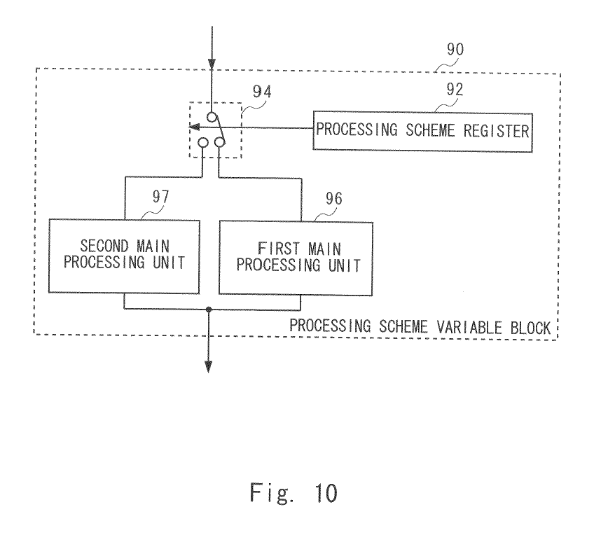

The parameter variable block 80 performs the processing 3 on the data from the bypassable block 70 and outputs a result to the processing scheme variable block 90. FIG. 9 shows an example of the configuration of the parameter variable block 80.

Referring to FIG. 9, the parameter variable block 80 includes a parameter register 82 and a main processing unit 84. The parameter register 82 stores a parameter to be used for the processing 3. The main processing unit 84 performs the processing 3 on the data from the bypassable block 70 and outputs a result to the processing scheme variable block 90. When executing the processing 3, the main processing unit 84 refers to the parameter stored in the parameter register 82.

With such a configuration of the parameter variable block 80, it is possible to change the parameter to be used when executing the processing 3.

The processing scheme variable block 90 is compatible with a plurality of (two in this example) processing schemes, and it performs the processing 4 on the data from the parameter variable block 80 by one of the plurality of processing schemes and outputs a result. In order to execute the processing by the respective processing schemes, processing units having different hardware configurations are necessary. FIG. 10 shows an example of the configuration of the processing scheme variable block 90.

Referring to FIG. 10, the processing scheme variable block 90 includes a processing scheme register 92, a scheme switch 94, a first main processing unit 96 and a second main processing unit 97.

The first main processing unit 96 performs the processing 4 by a first processing scheme, and the second main processing unit 97 performs the processing 4 by a second processing scheme.

The processing scheme register 92 stores a set value that indicates either the first processing scheme or the second processing scheme. The scheme switch 94 refers to the set value stored in the processing scheme register 92 and switches whether to output the data from the parameter variable block 80 to the first main processing unit 96 or the second main processing unit 97.

With such a configuration of the processing scheme variable block 90, it is possible to control by which processing scheme the processing 4 is performed during the frame processing by changing the set value stored in the processing scheme register 92.

By changing the values stored in the pass setting register 72, the parameter register 82 and the processing scheme register 92 in the frame processing circuit 50, it is possible to perform the frame processing of the three types of frames described above. This is described in detail below with respect to each frame.

### <Frame 1>

In this case, “no bypassing” is set to the pass setting register 72 of the bypassable block 70, “parameter corresponding to the frame 1” is set to the parameter register 82 of the parameter variable block 80, and “first processing scheme” is set to the processing scheme register 92 of the processing scheme variable block 90.

By such setting, the processing 1, the processing 2, the processing 3 and the processing 4 are sequentially executed in the frame processing circuit 50. In the processing 3, the parameter corresponding to the frame 1 is used. The processing 4 is performed by the first main processing unit 96 according to the first processing scheme. The frame processing for the frame 1 is thereby executed.

### <Frame 2>

In this case, “bypassing” is set to the pass setting register 72 of the bypassable block 70, “parameter corresponding to the frame 2” is set to the parameter register 82 of the parameter variable block 80, and “first processing scheme” is set to the processing scheme register 92 of the processing scheme variable block 90.

By such setting, the processing 1, the processing 3 and the processing 4 are sequentially executed in the frame processing circuit 50. In the processing 3, the parameter corresponding to the frame 2 is used. The processing 4 is performed by the first main processing unit 96 according to the first processing scheme. The frame processing for the frame 2 is thereby executed.

### <Frame 3>

In this case, “no bypassing” is set to the pass setting register 72 of the bypassable block 70, “parameter corresponding to the frame 3” is set to the parameter register 82 of the parameter variable block 80, and “second processing scheme” is set to the processing scheme register 92 of the processing scheme variable block 90.

By such setting, the processing 1, the processing 2, the processing 3 and the processing 4 are sequentially executed in the frame processing circuit 50. In the processing 3, the parameter corresponding to the frame 3 is used. The processing 4 is performed by the second main processing unit 97 according to the second processing scheme. The frame processing for the frame 3 is thereby executed.

As described above, the frame processing circuit 50 includes processing blocks that respectively execute a plurality of steps involved in the frame processing, and it can bypass a given processing block, change a parameter for a given processing block or change a processing scheme for a given processing block according to the type of data frame. This eliminates the need to include a frame processing unit for each type of data frame in an RFID device, and it is thereby possible to suppress a circuit scale. Further, because the frame processing is executed by hardware, it is possible to increase a processing speed and reduce a circuit scale compared to the case of using software.

The parameter variable block 80 may be configured to be both parameter variable and bypassable. Likewise, the processing scheme variable block 90 may be configured to be both bypassable and parameter variable. Thus, according to need, the frame processing circuit may include various types of processing blocks such as a bypassable/parameter variable processing block, a bypassable/processing scheme variable processing block, a parameter variable/processing scheme variable processing block and a bypassable/parameter variable/processing scheme variable processing block, in addition to the processing blocks shown in FIG. 5.

On the basis of the above description, an RFID system that implements the principle of the present invention is described hereinafter.

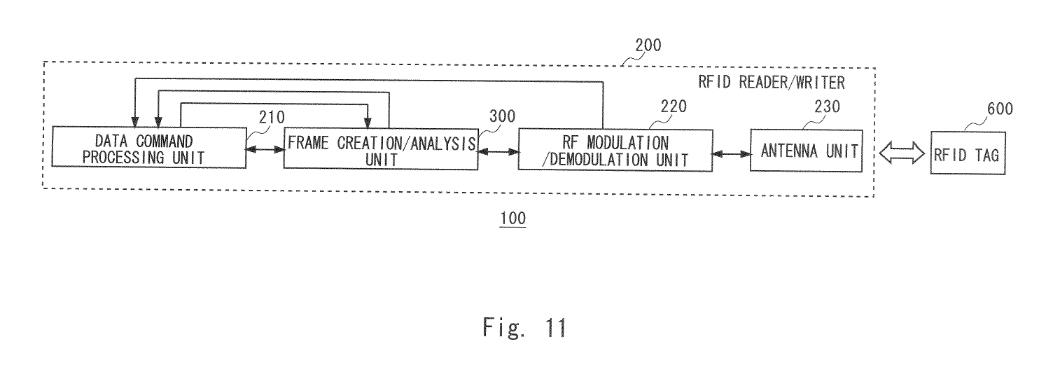

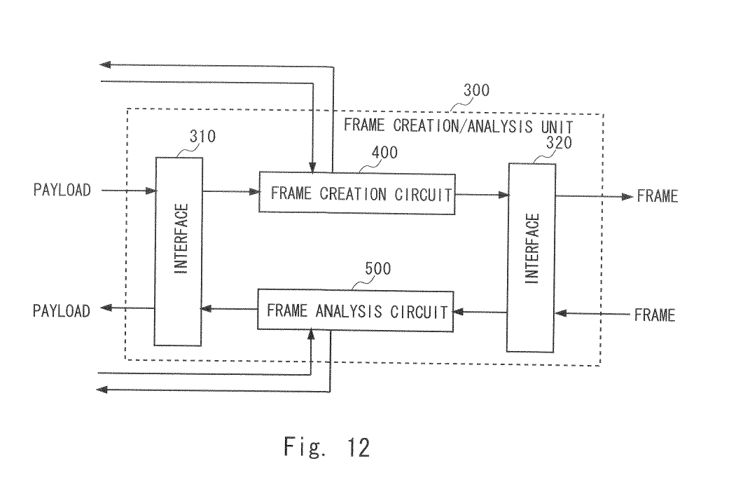

FIG. 11 shows an RFID system 100 according to an exemplary embodiment of the present invention. The RFID system 100 includes an RFID reader/writer 200 and an RFID tag 600. The RFID reader/writer 200 is compatible with a plurality of protocols: ISO14443A, ISO15693, ISO18092, ISO18000-6 and ISO18000-4. Therefore, when the RFID tag 600 is compliant to any of those protocols, the RFID reader/writer 200 can perform reading and writing.

The RFID reader/writer 200 includes a data command processing unit 210, a frame creation/analysis unit 300, an RF modulation/demodulation unit 220 and an antenna unit 230.

The data command processing unit 210 includes a CPU and performs control of the frame creation/analysis unit 300 and the RF modulation/demodulation unit 220, supply of Payload contained in a data frame to be transmitted to the RFID tag 600 to the frame creation/analysis unit 300, processing of Payload from the frame creation/analysis unit 300 and so on.

The frame creation/analysis unit 300 is a chip composed of a digital circuit, and it receives Payload from the data command processing unit 210, creates a data frame to be transmitted to the RFID tag 600 and outputs the data frame to the RF modulation/demodulation unit 220. Further, the frame creation/analysis unit 300 performs analysis processing on a data frame from the RF modulation/demodulation unit 220, acquires Payload and outputs Payload to the data command processing unit 210.

The RF modulation/demodulation unit 220 is an analog circuit, and it performs RF modulation on the data frame from the frame creation/analysis unit 300 and outputs a result to the antenna unit 230. Further, the RF modulation/demodulation unit 220 demodulates a radio wave signal received by the antenna unit 230 into a data frame and outputs the data frame to the frame creation/analysis unit 300. When demodulating the data frame, the RF modulation/demodulation unit 220 notifies the type of the data frame (a protocol type and a data format type in the protocol) to the data command processing unit 210.

The antenna unit 230 is compatible with a plurality of frequency bands and capable of transmitting and receiving radio signals based on the respective protocols described above.

FIG. 12 shows the frame creation/analysis unit 300. The frame creation/analysis unit 300 includes an interface 310 connected to the data command processing unit 210, an interface 320 connected to the RF modulation/demodulation unit 220, a frame creation circuit 400 and a frame analysis circuit 500.

The interface 310 performs parallel-to-serial conversion on Payload from the data command processing unit 210 and outputs a result to the frame creation circuit 400, and performs serial-to-parallel conversion on Payload from the frame analysis circuit 500 and outputs a result to the data command processing unit 210.

The frame creation circuit 400 creates a data frame from Payload from the data command processing unit 210 through the interface 310 and outputs the data frame to the interface 320.

The frame analysis circuit 500 analyzes a data frame from the interface 320, acquires Payload and outputs it to the interface 310.

The interface 320 includes a flip-flop and matches the timing of the processing of the frame creation/analysis unit 300 and the RF modulation/demodulation unit 220 or the like.

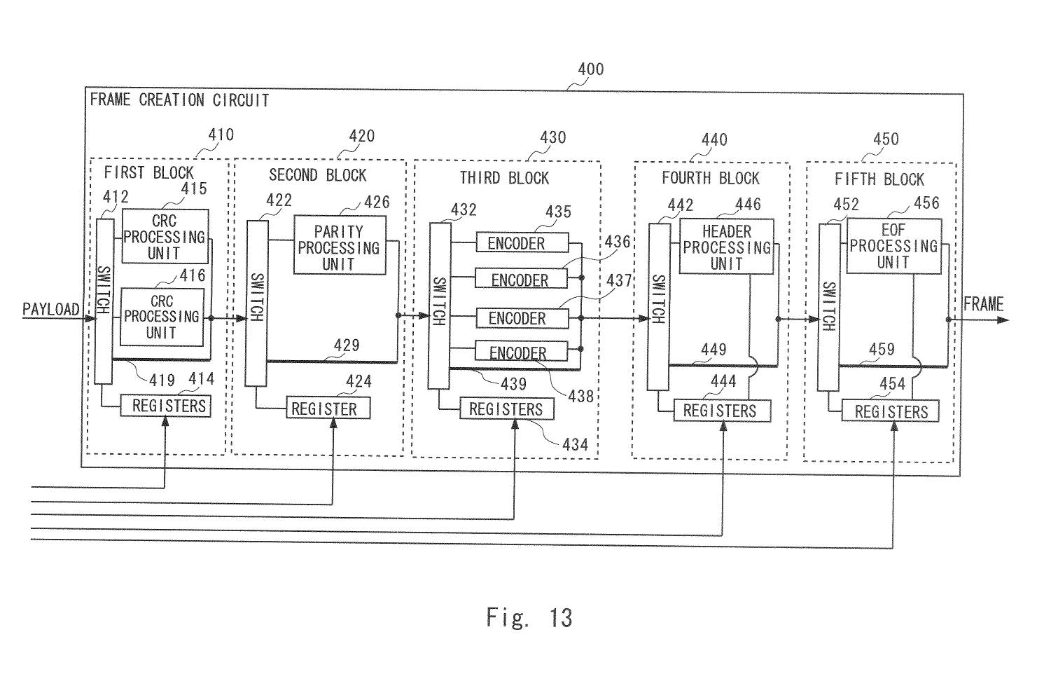

FIG. 13 shows the frame creation circuit 400. The frame creation circuit 400 is the frame processing circuit according to an exemplary embodiment of the present invention which is applied to frame creation processing, and it includes five (first to fifth) blocks that are sequentially connected in a bypassable manner.

A first block 410 is capable of executing CRC processing, and it includes a switch 412, registers 414, CRC processing units 415 and 416 and a bypass 419. The registers 414 include a pass setting register that stores a set value indicating whether to bypass CRC processing and a processing scheme register that stores a set value indicating a CRC processing scheme. Those registers are set by the data command processing unit 210 according to the type of frame to be created.

In this example, the CRC processing scheme means the number of bits of CRC data to be added to Payload, and compatibility with two processing schemes is established in this exemplary embodiment. For example, the CRC processing unit 415 adds 16-bit CRC data, and the CRC processing unit 416 adds 5-bit CRC data.

The switch 412 refers to each register of the registers 414 and makes switching for outputting Payload received from the data command processing unit 210 through the interface 310 to either one of the CRC processing unit 415, the CRC processing unit 416 and the bypass 419. Specifically, if “bypassing” is set to the pass setting register, the switch 412 makes switching to the bypass 419 and outputs Payload as it is to a second block 420 in the subsequent stage. On the other hand, if “no bypassing” is set to the pass setting register, the switch 412 makes switching to the CRC processing unit corresponding to the CRC processing scheme set to the processing scheme register. The CRC processing unit adds CRC data to the received Payload and outputs a result to the second block 420.

Thus, the first block 410 is a bypassable/processing scheme variable block. The switch 412 serves both as a pass switch and a scheme switch.

The second block 420 is a bypassable block, and it outputs the data received from the first block 410 to a third block 430 without performing any processing or after performing parity processing. The second block 420 includes a switch 422, a register 424, a parity processing unit 426 and a bypass 429. The parity processing unit 426 executes party processing. The register 424 is a pass setting register and stores a set value indicating whether to bypass the processing of the parity processing unit 426. The register 424 is also set by the data command processing unit 210 according to the type of frame to be created.

The switch 422 is a pass switch: and it refers to the register 424 and makes switching for outputting the data from the first block 410 to either the parity processing unit 426 or the bypass 429. If switching is made to the bypass 429, the data from the first block 410 is output as it is to the third block 430 without performing parity processing. If, on the other hand, switching is made to the parity processing unit 426, the data from the first block 410 is output to the third block 430 after performing parity processing by the parity processing unit 426.

The third block 430 is a bypassable/processing scheme variable block, and it includes a switch 432, registers 434, four encoders 435 to 438 and a bypass 439. The encoders 435 to 438 perform encoding by different encoding schemes. The registers 434 include a pass setting register that stores a set value indicating whether to perform encoding, which is, whether to bypass all the encoders 435 to 438, and a processing scheme register that stores a set value indicating an encoding scheme when performing encoding (not bypassing the encoding). Those registers are set by the data command processing unit 210 according to the type of frame to be created.

The switch 432 serves both as a pass switch and a scheme switch, and it refers to the set value of each register of the registers 434 and makes switching for outputting the data from the second block 420 to either one of the encoder 435, the encoder 436, the encoder 437, the encoder 438 and the bypass 439. Specifically, if “bypassing” is set, the switch 432 makes switching to the bypass 439. The data from the second block 420 is thereby output as it is to a fourth block 440 in the subsequent stage through the bypass 439.

On the other hand, if “no bypassing” is set, the switch 432 makes switching to the encoder corresponding to the set encoding scheme. The encoder encodes the received data and outputs the encoded data to the fourth block 440.

The fourth block 440 is a bypassable/parameter variable block, and it includes a switch 442, registers 444, a header processing unit 446 and a bypass 449. The registers 444 include a pass setting register that stores a set value indicating whether to bypass header processing by the header processing unit 446, and a parameter register that stores a necessary parameter when not bypassing the processing. The header processing performed by the header processing unit 446 is the start data processing in the frame creation processing, and parameters for the processing are the number of bits of start data and the data value of start data. The set value and the parameters are set by the data command processing unit 210 according to the type of data frame to be created. Further, in the case of a frame that is defined to encode the start data or part of the start data, it is set so as to encode the relevant part.

The switch 442 is a pass switch, and it refers to each register of the registers 444 and makes switching for outputting the data from the third block 430 to either the header processing unit 446 or the bypass 449. Specifically, if “bypassing” is set, the switch 442 makes switching to the bypass 449. The data from the third block 430 is thereby output as it is to a fifth block 450 in the subsequent stage through the bypass 449. On the other hand, if “no bypassing” is set, the switch 442 makes switching to the header processing unit 446. The header processing unit 446 reads the set number of bits of data from the parameter register, adds it to the data from the third block 430 and outputs a result to the fifth block 450.

The fifth block 450 is also a bypassable/parameter variable block, and it includes a switch 452. registers 454, an EOF processing unit 456 and a bypass 459. The registers 454 include a pass setting register that stores a set value indicating whether to bypass EOF processing by the EOF processing unit 456, and a parameter register that stores a necessary parameter when not bypassing the processing. The EOF processing performed by the EOF processing unit 456 is the end data processing in the frame creation processing, and parameters for the processing are the number of bits of end data and the data value of end data. The set value and the parameters are set by the data command processing unit 210 according to the type of data frame to be created. Further, in the case of a frame that is defined to encode the end data or part of the end data, it is set so as to encode the relevant part.

The switch 452 is a pass switch, and it refers to each register of the registers 454 and makes switching for outputting the data from the fourth block 440 to either the EOF processing unit 456 or the bypass 459. Specifically, if “bypassing” is set, the switch 452 makes switching to the bypass 459. The data from the fourth block 440 is thereby output as it is through the bypass 459. On the other hand, if “no bypassing” is set, the switch 452 makes switching to the EOF processing unit 456. The EOF processing unit 456 reads the set number of bits of data from the parameter register, adds it to the data from the fourth block 440 and outputs a result as a data frame.

As described above, the frame creation circuit 400 according to the exemplary embodiment includes five processing blocks respectively corresponding to CRC processing, parity processing, encoding, start data processing and end data processing, and each processing block is bypassable. Further, the processing blocks in which a parameter to be used for processing is different depending on the type of data frame (e.g. the fourth block 440 and the fifth block 450) are configured to be capable of varying a parameter. Further, the processing blocks in which a processing scheme is different depending on the type of data frame (e.g. the first block 410 and the third block 430) are configured to be capable of varying a processing scheme, having main processing units (e.g. the CRC processing unit 415 and the CRC processing unit 416 in the first block 410 or the encoders 435 to 438 in the third block 430) for respective processing schemes.

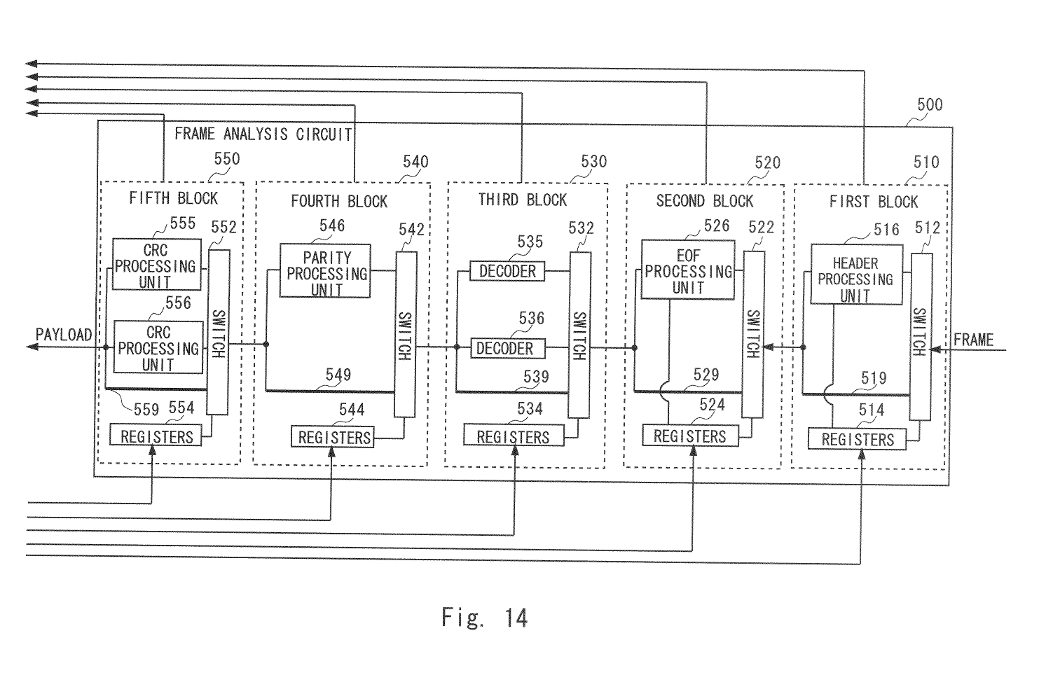

FIG. 14 is a view showing the frame analysis circuit 500 in the RFID reader/writer 200. The frame analysis circuit 500 is the frame processing circuit according to an exemplary embodiment of the present invention which is applied to frame analysis processing, and it includes five (first to fifth) blocks that are sequentially connected in a bypassable manner.

A first block 510 is a bypassable/parameter variable block, and it includes a switch 512, registers 514, a header processing unit 516 and a bypass 519. The registers 514 include a pass setting register that stores a set value indicating whether to bypass header processing by the header processing unit 516, and a parameter register that stores a necessary parameter when not bypassing the processing. The header processing performed by the header processing unit 516 is the start data processing in the frame analysis processing, and parameters for the processing are the number of bits of start data, an expected value of start data, and information indicating whether to output an analysis result in the start data processing. As described earlier, when the RF modulation/demodulation unit 220 demodulates a received signal into a data frame, it notifies the type to the data command processing unit 210. The data command processing unit 210 sets the register of each block according to the notified type. The expected value of start data is set to the register by the data command processing unit 210 at the time of transmitting the data frame.

Whether to output an analysis result in the start data processing is described hereinafter by referring back to FIG. 5. As shown in FIG. 5, in the case of ISO18092, Preamble, SYNC and LENGTH are contained in the start data. SYNC indicates Polarity and it is necessary for decoding. Thus, in the analysis processing of the data frame based on ISO18092, it is necessary to output Polarity obtained by the start data processing in the subsequent stage. The data command processing unit 210 sets the register included in the registers 514 of the first block 510 to output Polarity, which is an analysis result, if the notified type of data frame is a standard frame of ISO18092. Further, because LENGTH is also necessary for decoding, the data command processing unit 210 sets the register to also output LENGTH.

The switch 512 switches between the header processing unit 516 and the bypass 519 by referring to the pass setting register included in the registers 514. If switching is made to the bypass 519, the data frame from the RF modulation/demodulation unit 220 is output as it is to a second block 520 through the bypass 519. If switching is made to the header processing unit 516, the header processing unit 516 performs start data processing on the data frame from the RF modulation/demodulation 220 by referring to the parameter register included in the registers 514, and outputs a result to the second block 520.

The second block 520 is a bypassable/parameter variable block, and it includes a switch 522, registers 524, an EOF processing unit 526 and a bypass 529. The registers 524 include a pass setting register and a parameter register, and the switch 522 switches between the EOF processing unit 526 and the bypass 529 by referring to the pass setting register. If switching is made to the bypass 529, the data from the first block 510 is output as it is to a third block 530 through the bypass 529. If switching is made to the EOF processing unit 526. the EOF processing unit 526 performs end data processing for analysis processing on the data from the first block 510 by referring to the parameter register and outputs a result to the third block 530.

The third block 530 is a bypassable/processing scheme variable block, and it includes a switch 53,. registers 534, a decoder 535, a decoder 536 and a bypass 539. The registers 534 include a pass setting register and a processing scheme register, and the switch 532 switches among the decoder 535, the decoder 536 and the bypass 539 by referring to those registers. If switching is made to the bypass 539, the data from the second block 520 is output as it is to a fourth block 540 through the bypass 539 without being decoded. On the other hand, if switching is made to the decoder 535 or the decoder 536, the decoder performes decoding on the data from the second block 520 and outputs the decoded data to the fourth block 540.

For example, in the case of the standard frame of the protocol of ISO14443A, only Payload and CRC, which is only PAYCRC, is output from the second block 520 to the third block 530. On the other hand, in the case of ISO18092, Polarity and LENGTH are output in addition to PAYCRC from the second block 520 to the third block 530. Thus, in the decoding of PAYCRC of ISO18092, LENGTH is detected, and PAYCRC is decoded by referring to Polarity and the detected LENGTH, which is different from a processing scheme in the case of ISO14443A. Because a processing scheme to be used for decoding is set to a processing scheme parameter, it is compatible with decoding of a data frame with a different decoding scheme by making switching to the decoder corresponding to the processing scheme by the switch 522.

The fourth block 540 is a bypassable block, and it includes a switch 542, a register 544, a parity processing unit 546 and a bypass 549. The register 544 is a pass setting register, and the switch 542 switches between the parity processing unit 546 and the bypass 549 by referring to the register 544. If switching is made to the bypass 549, the data from the third block 530 is output as it is to a fifth block 550 through the bypass 549. If, on the other hand, switching is made to the parity processing unit 546, the parity processing unit 546 performs parity processing on the data from the third block 530 to delete the parity bit and outputs a result to the fifth block 550.

The fifth block 550 is a bypassable/processing scheme variable block, and it includes a switch 552, registers 554, a CRC processing unit 555, a CRC processing unit 556 and a bypass 559. The registers 554 include a pass setting register and a processing scheme register, and the switch 552 switches among the CRC processing unit 555, the CRC processing unit 556 and the bypass 559 by referring to the registers. If switching is made to the bypass 559, the data from the fourth block 540 is output as Payload through the bypass 559 without performing CRC processing. On the other hand, if switching is made to the CRC processing unit 555 or the CRC processing unit 556, the CRC processing unit performs CRC processing on the data from the fourth block 540, acquires Payload and outputs it.

The first block 510 to the fifth block 550 output an error signal to the data command processing unit 210 if they detect an error during processing when not bypassing the processing. The analysis processing is thereby discontinued.

As described above, the frame analysis circuit 500 according to the exemplary embodiment includes five processing blocks respectively corresponding to start data processing, end data processing, decoding, parity processing and CRC processing, and each processing block is bypassable. Further, the processing blocks in which a parameter to be used for processing is different depending on the type of data frame (e.g. the first block 510 and the second block 520) are configured to be capable of varying a parameter. Further, the processing blocks in which a processing scheme is different depending on the type of data frame (e.g. the third block 530 and the fifth block 550) are configured to be capable of varying a processing scheme, having main processing units (e.g. the decoder 535 and the decoder 536 in the third block 530 or the CRC processing unit 555 and the CRC processing unit 556 in the fifth block 550) for respective processing schemes.

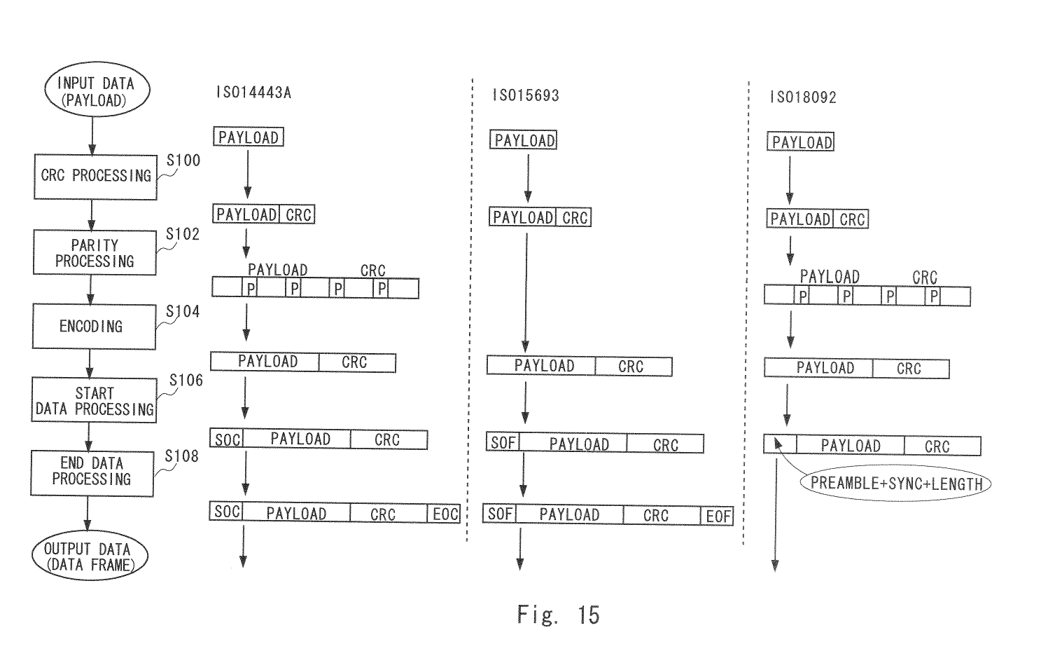

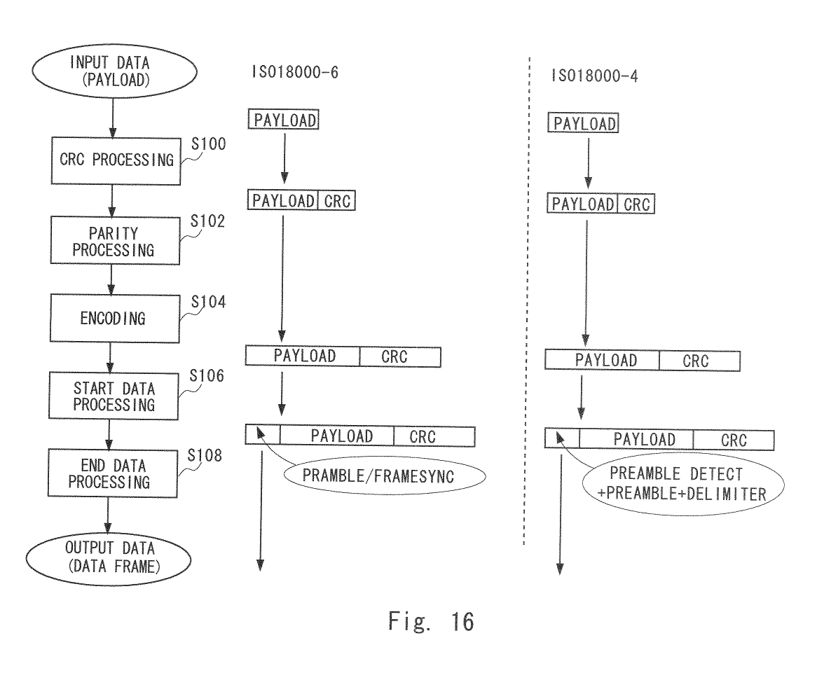

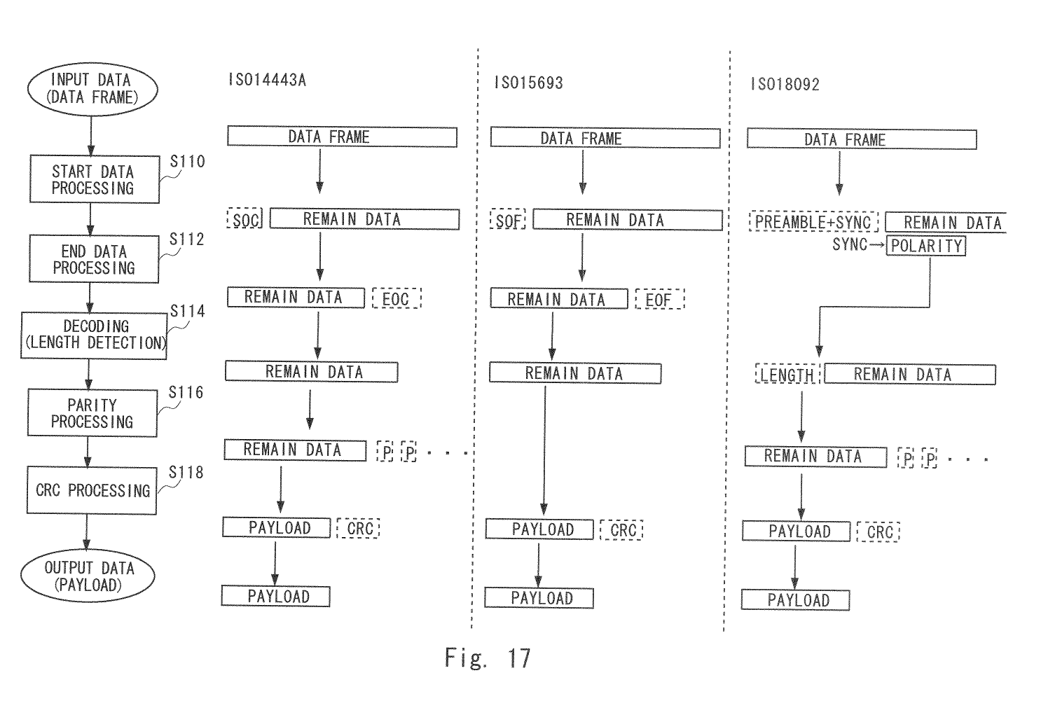

FIGS. 15 and 16 show the flow when the frame creation circuit 400 creates a data frame based on each of the above-described five protocols. For simplification, only the standard frame is described for the respective protocols.

Referring to FIG. 15, in the creation of the standard frame based on ISO14443A, CRC processing (S100) by the first block 410, parity processing (S102) by the second block 420, encoding (S104) by the third block 430, start data processing (S106) by the fourth block 440, and end data processing (S108) by the fifth block 450 are executed sequentially.

In the creation of the standard frame based on ISO15693, the CRC processing (S100) by the first block 410, the encoding (S104) by the third block 430, the start data processing (S106) by the fourth block 440, and the end data processing (S108) by the fifth block 450 are executed sequentially. The parity processing (S102) by the second block 420 is bypassed.

In the creation of the standard frame based on ISO18092, the CRC processing (S100) by the first block 410, the parity processing (S102) by the second block 420, the encoding (S104) by the third block 430, and the start data processing (S106) by the fourth block 440 are executed sequentially. The end data processing (S108) by the fifth block 450 is bypassed.

Referring further to FIG. 16, in the creation of the standard frame based on ISO18000-6, the CRC processing (S100) by the first block 410, the encoding (S104) by the third block 430, and the start data processing (S106) by the fourth block 440 are executed sequentially. The parity processing (S102) by the second block 420 and the end data processing (S108) by the fifth block 450 are bypassed.

In the creation of the standard frame based on ISO18000-4, the CRC processing (S100) by the first block 410, the encoding (S104) by the third block 430, and the start data processing (S106) by the fourth block 440 are executed sequentially. The parity processing (S102) by the second block 420 and the end data processing (S108) by the fifth block 450 are bypassed.

Further, among the steps S100 to S108, in the step where a parameter to be used for processing is different depending on protocol, a parameter corresponding to the protocol is used, and in the step where a processing scheme is different depending on protocol, processing is executed by a processing scheme corresponding to the protocol.

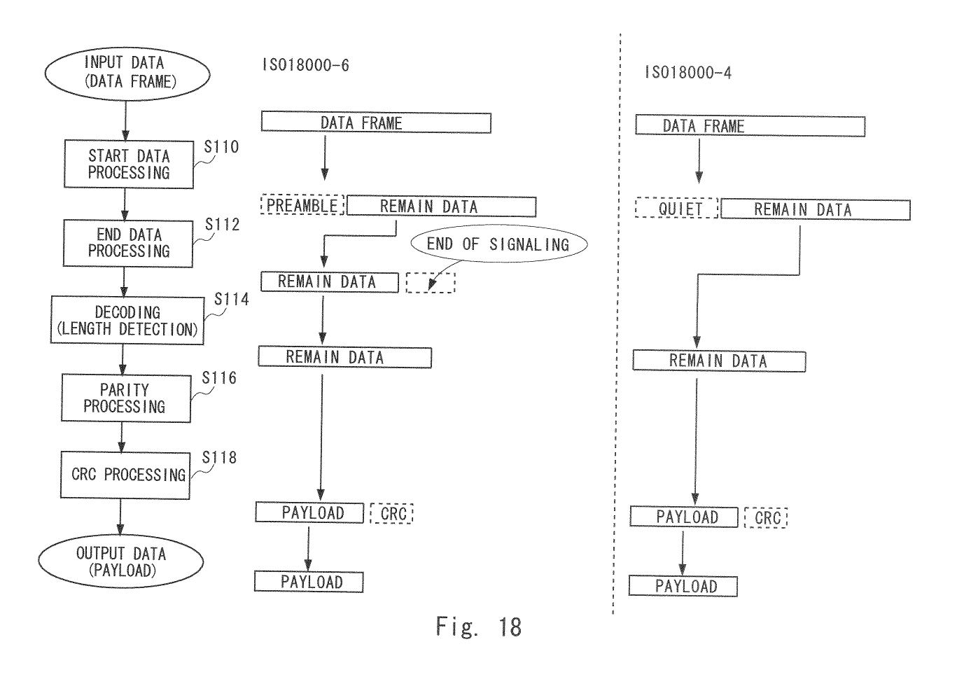

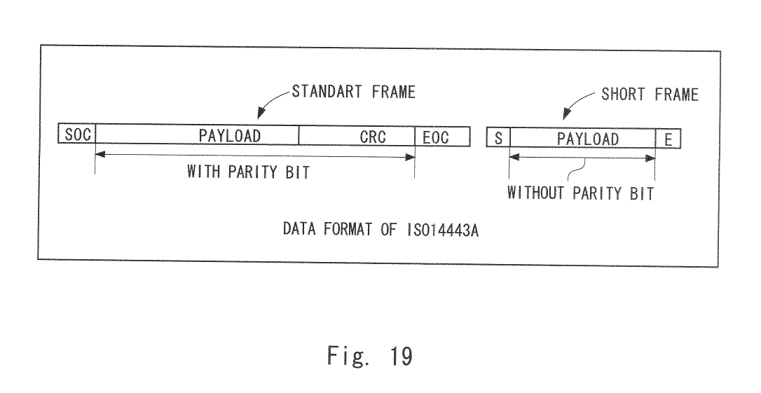

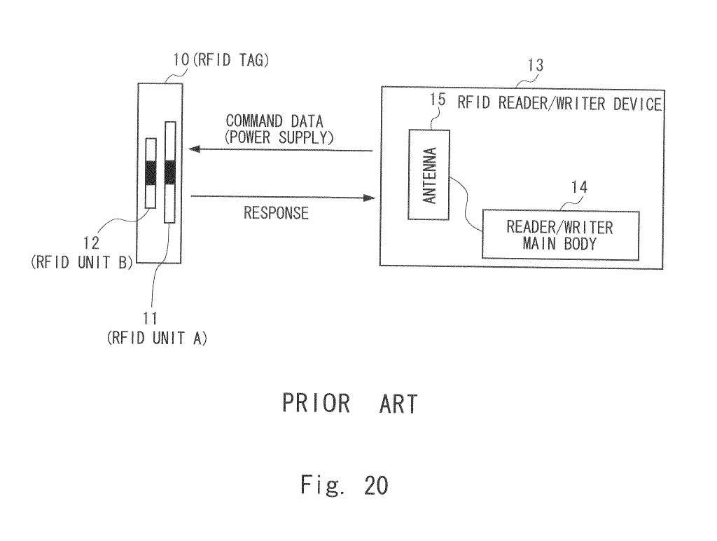

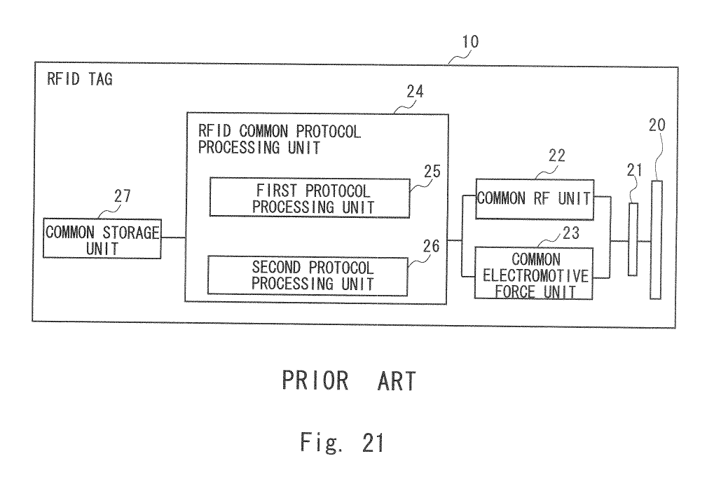

FIGS. 17 and 18 show the flow when the frame analysis circuit 500 analyzes a data frame based on each of the above-described five protocols. For simplification, only the standard frame is described for the respective protocols.

Referring to FIG. 17, in the analysis of the standard frame based on ISO14443A, start data processing (S110) by the first block 510, end data processing (S112) by the second block 520, decoding (S114) by the third block 530, parity processing (S116) by the fourth block 540, and CRC processing (S118) by the fifth block 550 are executed sequentially.

In the analysis of the standard frame based on ISO15693, the start data processing (S110) by the first block 510, the end data processing (S112) by the second block 520, the decoding (S114) by the third block 530, and the CRC processing (S118) by the fifth block 550 are executed sequentially. The parity processing (S116) by the fourth block 540 is bypassed.

In the analysis of the standard frame based on ISO18092, the start data processing (S110) by the first block 510, the decoding (S114) by the third block 530, the parity processing (S116) by the fourth block 540, and the CRC processing (S118) by the fifth block 550 are executed sequentially. The end data processing (S112) by the second block 520 is bypassed. Further, in the case of ISO18092, the polarity data (Polarity) obtained from SYNC during the start data processing (S110) is transferred to the third block 530 and used for decoding. During the decoding (S114), detection of LENGTH is also performed.

Referring further to FIG. 18, in the analysis of the standard frame based on ISO18000-6, the start data processing (S110) by the first block 510, the end data processing (S112) by the second block 520, the decoding (S114) by the third block 530, and the CRC processing (S118) by the fifth block 550 are executed sequentially. The parity processing (S116) by the fourth block 540 is bypassed.

In the analysis of the standard frame based on ISO18000-4, the start data processing (S110) by the first block 510, the decoding (S114) by the third block 530, and the CRC processing (S118) by the fifth block 550 are executed sequentially. The end data processing (S112) by the second block 520 and the parity processing (S116) by the fourth block 540 are bypassed.

Further, among the steps S110 to S118, in the step where a parameter to be used for processing is different depending on protocol, a parameter corresponding to the protocol is used, and in the step where a processing scheme is different depending on protocol, processing is executed by a processing scheme corresponding to the protocol.

As described above, the frame creation/analysis unit 300 according to the exemplary embodiment is compatible with a plurality of protocols: ISO14443A, ISO15693, IS018092, ISO18000-6 and ISO18000-4, and it is capable of creating and analyzing data frames of various formats in respective protocols. Further, the creation processing and the analysis processing are divided into a plurality of steps, the processing blocks for performing the respective steps are configured to be bypassable, and only the necessary processing block is executed according to the type of data frame, thereby maximally sharing the shareable processing blocks between the respective data frames. It is thereby possible to reduce a circuit scale compared to related art in which a creation processing unit and an analysis processing unit are provided for each type of data frame. Further, because creation processing and analysis processing are performed by hardware, it is possible to increase the processing speed.

Although the RFID reader/writer 200 is compatible with a plurality of protocols in the above-described exemplary embodiment, the technique of the present invention may be also applied to frame processing of data frames of different formats in a single protocol.

Further, in the RFID reader/writer 200, all processing blocks are configured to be bypassable for a new protocol to be emerged in the future. However, in the case of making compatibility with only the above-described five protocols, for example, the processing block for performing the start data processing may be configured to be non-bypassable.

Further, although the technique of the present invention is applied to an RFID reader/writer in the above-described exemplary embodiment, the technique of the present invention may be applied to an RFID tag.

Although the operation of a section for performing frame creation processing and the operation of a section for performing frame analysis processing are described separately for easier understanding, the section for performing frame creation processing and the section for performing frame analysis processing may operate in parallel in an RFID device to which the technique of the present invention is applied.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

1. A frame processing circuit for performing frame processing that is creation processing of creating an RFID data frame from a payload or analysis processing of analyzing an RFID data frame and obtaining a payload, the frame processing including m (1≦m≦n) number of processing steps according to a type of data frame among n (n is an integer of 2 or above) number of processing steps, the circuit comprising:
n-number of processing blocks that respectively execute the n-number of processing steps,
wherein the n-number of processing blocks include a bypassable block where setting of whether to bypass processing can be made according to a type of data frame, that performs processing of a relevant step on received data and outputs processed data if no bypassing is set, and outputs received data without performing any processing if bypassing is set.

2. The frame processing circuit according to claim 1, wherein the type of data frame involves a type of data format in one protocol.

3. The frame processing circuit according to claim 1, wherein the type of data frame involves a type of protocol.

4. The frame processing circuit according to claim 2, wherein the type of data frame involves a type of protocol.

5. The frame processing circuit according to claim 1, wherein the n-number of processing blocks include a parameter variable block where setting of a parameter to be used for processing of a relevant step can be made according to a type of data frame, that performs processing of the step by referring to the set parameter.

6. The frame processing circuit according to claim 1, wherein the bypassable block comprises:
a main processing unit that executes processing of a relevant step on received data;
a bypass that outputs received data without performing any processing;
a pass setting register where a set value indicating whether to bypass processing is writable; and
a pass switch that switches between outputting data from a previous stage to the main processing unit and outputting the data to the bypass based on the set value written to the pass setting register.

7. The frame processing circuit according to claim 2, wherein the bypassable block comprises:
a main processing unit that executes processing of a relevant step on received data;
a bypass that outputs received data without performing any processing;
a pass setting register where a set value indicating whether to bypass processing is writable; and
a pass switch that switches between outputting data from a previous stage to the main processing unit and outputting the data to the bypass based on the set value written to the pass setting register.

8. The frame processing circuit according to claim 3, wherein the bypassable block comprises:
a main processing unit that executes processing of a relevant step on received data;
a bypass that outputs received data without performing any processing;
a pass setting register where a set value indicating whether to bypass processing is writable; and
a pass switch that switches between outputting data from a previous stage to the main processing unit and outputting the data to the bypass based on the set value written to the pass setting register.

9. The frame processing circuit according to claim 4, wherein the bypassable block comprises:
a main processing unit that executes processing of a relevant step on received data;
a bypass that outputs received data without performing any processing;
a pass setting register where a set value indicating whether to bypass processing is writable; and
a pass switch that switches between outputting data from a previous stage to the main processing unit and outputting the data to the bypass based on the set value written to the pass setting register.

10. The frame processing circuit according to claim 5, wherein the bypassable block comprises:
a main processing unit that executes processing of a relevant step on received data;
a bypass that outputs received data without performing any processing;
a pass setting register where a set value indicating whether to bypass processing is writable; and
a pass switch that switches between outputting data from a previous stage to the main processing unit and outputting the data to the bypass based on the set value written to the pass setting register.

11. The frame processing circuit according to claim 5, wherein
the parameter variable block comprises:
a main processing unit that executes processing of a relevant step on received data; and
a parameter register where the parameter is writable, and
the main processing unit executes processing of the step by using the parameter written to the parameter register.

12. The frame processing circuit according to claim 10, wherein
the parameter variable block comprises:
a main processing unit that executes processing of a relevant step on received data; and
a parameter register where the parameter is writable, and
the main processing unit executes processing of the step by using the parameter written to the parameter register.

13. The frame processing circuit according to claim 1, wherein the n-number of processing blocks include a processing scheme variable block comprising a plurality of main processing units that execute processing of a relevant step by different schemes and capable of switching among the plurality of main processing units according to a type of data frame.

14. The frame processing circuit according to claim 13, wherein the processing scheme variable block comprises:
a processing scheme setting register where a set value indicating a processing scheme of a relevant step is writable; and
a scheme switch that switches among the plurality of main processing units based on the set value written to the processing scheme setting register.

15. The frame processing circuit according to claim 1, wherein
the frame processing circuit performs the creation processing, and
the n-number of processing blocks respectively execute CRC processing, parity processing, encoding, start data processing and end data processing.

16. The frame processing circuit according to claim 1, wherein
the frame processing circuit performs the analysis processing, and
the n-number of processing blocks respectively execute start data processing, end data processing, decoding, parity processing and CRC processing.

17. A frame processing chip comprising:
a frame creation circuit that is the frame processing circuit according to claim 15; and
a frame analysis circuit that is a frame processing circuit for performing frame processing that is creation processing of creating an RFID data frame from a payload or analysis processing of analyzing an RFID data frame and obtaining a payload, the frame processing including m (1≦m≦n) number of processing steps according to a type of data frame among n (n is an integer of 2 or above) number of processing steps, the circuit comprising:
n-number of processing blocks that respectively execute the n-number of processing steps,
wherein the n-number of processing blocks include a bypassable block where setting of whether to bypass processing can be made according to a type of data frame, that performs processing of a relevant step on received data and outputs processed data if no bypassing is set, and outputs received data without performing any processing if bypassing is set; wherein
the frame processing circuit performs the analysis processing, and
the n-number of processing blocks respectively execute start data processing, end data processing, decoding, parity processing and CRC processing.

18. An RFID reader/writer comprising:
an antenna;
an RF modulation/demodulation unit that performs RF modulation of a data frame from the frame processing chip according to claim 17 and outputs a result to the antenna, and performs RF demodulation of a signal received by the antenna and outputs a result to the frame processing chip; and
a data command processing unit including a CPU, that performs control processing including supply of a payload to the frame processing chip, processing of a payload from the frame processing chip, and setting of each processing block in the frame processing chip.
